(19) United States
(12) Patent Application Publication
(10) Pub. No.: US 2005/0060931 A1
(43) Pub. Date: Mar. 24, 2005

(54) Protective cover for a plant grazing container

(76) Inventor: John E. White, Ottawa (CA)

Correspondence Address: SHAPIRO COHEN;Station D, P.O. Box 3440, Ottawa, ON, K1P 6P1, CA

(21) Appl. No.: 10/667,405

(22) Filed: Sep. 23, 2003

(51) Int. Cl. A01G 9/02

(52) U.S. Cl. 47/65.5

(57) ABSTRACT

The present invention provides a grazing container for growing a plant variety, such as grass, and making it accessible for a small animal to graze on while preventing access to the growing medium. The apparatus consists of a cover and a container, whereby the cover prevents the unwanted access of the small animal by ensuring that the cover is constructed and arranged to prevent the small animal from the displacing the cover relative to the container. The cover consists of a framed grid having a plurality of openings. The container is filled with a growing medium, and seeded to grow one or more plant varieties. The plurality of openings in the cover is dimensioned to allow grass to grow through while preventing limbs of small animals from extending through the grid. These openings also allow watering of the growing medium without the need to remove the cover. The cover may also have a larger opening dimensioned to allow a person to extend a human finger through the larger opening to feel the growing medium for moisture content, yet prevent small animal limbs, such as cat paws, from entering the larger opening. The present invention may also include an attachment member or locking mechanism for securing the cover to the container.

### BACKGROUND OF THE INVENTION

1. Field of the Invention

The present invention relates to an apparatus for growing and making a plant variety available to animals, such as cats, for grazing while preventing them from digging into the growing medium and pulling out the plants.

### DESCRIPTION OF THE PRIOR ART

There is a number of grass kits available on the market that consist of a growing tray filled with a growing medium. Typically, these kits are intended for use by cats and are seeded with grass seeds, usually of the oats or rye variety. These prior art kits require the following steps: 1) placing the tray on the floor, 2) adding water, and 3) allowing a cat access to the grass as it is growing. Unfortunately, the current cat grass kits do not prevent a cat from digging into the growing medium. Also, without any type of protective cover maintaining the grass in the tray, cats will often pull out the grass rather than chew off the grass tips. Thus, it is desirable to have a plant grazing growing medium that contains and protects the plants from the digging activities of animals, such as cats. There is also need to allow for moisture content testing of the growing medium by touch without the need to remove the cover. Furthermore, the grower may want to water the plants without having to remove the cover each time. Such an apparatus would allow an animal to graze on a plant, such as grass, without being able to easily remove the grass from the tray.

In view of the above-noted shortcomings, the present invention seeks to provide a plant-growing medium having a cover which allows animals such as cats to graze while preventing them from pulling out the plant variety from the growing medium.

### SUMMARY OF THE INVENTION

The present invention provides a grazing container for growing a plant variety, such as grass, and making it accessible for a small animal to graze on while preventing access to the growing medium. The apparatus consists of a cover and a container, whereby the cover prevents the unwanted access of the small animal. The cover consists of a framed grid having a plurality of openings. The container is filled with a growing medium, and seeded to grow one or more plant varieties. The plurality of openings in the cover is dimensioned to allow grass to grow through while preventing limbs of small animals from extending through the grid. These openings also allow watering of the growing medium without the need to remove the cover. The cover may also have a larger opening dimensioned to allow a person to extend a human finger through the larger opening to feel the growing medium for moisture content, yet prevent small animal limbs, such as a cat's paw, from entering the larger opening. The present invention may also include an attachment member or locking mechanism for securing the cover to the container.

In a first aspect, the present invention provides an apparatus for growing at least one plant variety, and making the at least one plant variety accessible to animals for grazing, comprising: a container having suitable means for growing the at least one plant variety; and a cover for enclosing the container, the cover having a plurality of openings dimensioned for passage of the at least one plant variety through the plurality of openings while preventing limbs from the animals from passing through the plurality of openings.

In a second aspect, the present invention provides a cover for use with a container having suitable means for growing the at least one plant variety accessible to animals for grazing, the cover dimensioned for suitable use with the container, the cover having a plurality of openings being dimensioned to form a passageway for the at least plant variety growing through the plurality of openings while the cover preventing a limb from an animal from entering through any one of the plurality of openings.

In a third aspect, the present invention provides a kit comprising: a container having means suitable for growing at least one plant variety; and a cover for enclosing the container, the cover having a plurality of openings dimensioned for passage of the at least one plant variety through the plurality of openings while preventing limbs from animals from passing through the plurality of openings.

### BRIEF DESCRIPTION OF THE DRAWINGS

The present invention will now be described with reference to drawings, in which:

FIG. 1 is an exploded perspective view of a cover and a grazing container suitable for use with the cover in accordance with a first embodiment of the present invention;

FIG. 2 is an exploded perspective view of a cover and a grazing container with a removable growing tray in accordance with a second embodiment of the present invention;

FIG. 3 is a perspective view of a cover according to a second embodiment of the present invention where the cover is attached to the container through use of hinges and a locking mechanism in accordance with a third embodiment of the present invention; and

FIG. 4 is a perspective view of an embodiment of a cover of the present invention placed over a grazing container where grass is growing therethrough.

### DETAILED DESCRIPTION OF THE INVENTION

The invention will be described for the purposes of illustration only in connection with certain embodiments. However, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

For the purposes of the present invention, it is understood that there are a variety of plants which are suitable for animal grazing. However, the present invention will mainly refer to grass, as this is the preferred plant of cats. Growing mediums, such as soil, peat moss, vermiculite, perlite, or some combination of the many different types of growing mediums, may be suitable for the purposes of the present invention. For grass, seeds such as oats, rye, or any other member of the grass family, are also suitable. Oats are usually recommended because of their wide, tender leaf blades.

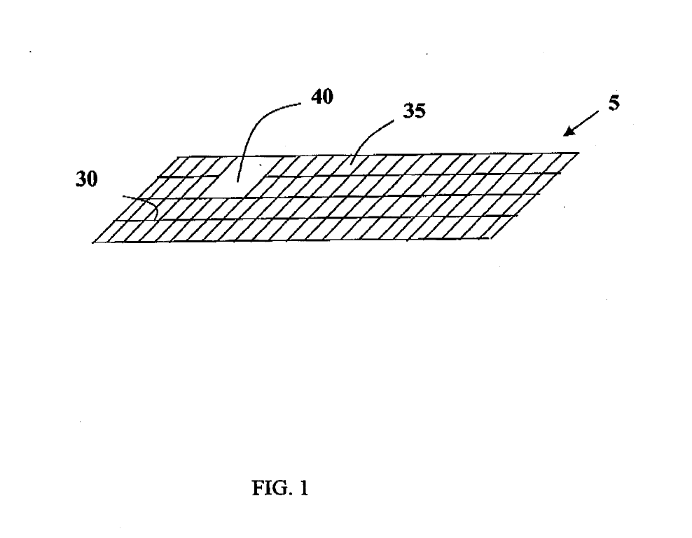

FIG. 1 shows a cover 5 of the present invention for use with a container 10. The container 10 has a base end 15 and four side walls 20a, 20b, 20c, 20d, for growing therein a plant variety, such as grass. The cover 5 has a frame 25 and a grid surface 30. The frame 25 supports the grid surface 30. The grid surface 30 is important in that there is a plurality of openings 35 dimensioned for the purposes of the present invention. The grid surface 30 is made of suitable material, such as a metal, to withstand the weight of a small animal on the cover 5.

In FIG. 1, the cover 5 is shown with a frame 25 having side walls which are dimensioned to mate with the corresponding four side walls 20a, 20b, 20c, 20d of the container 10. While there is no locking device shown, the present invention may further include an attachment means, such as hinges, or a locking mechanism, well known in the art, to permanently attach the cover 5 to the container 10. The locking mechanism would be useful in preventing a small animal from removing the cover 5 after it has been placed over the container 10. The openings 35 in the grid surface 30 are dimensioned to enable grass such as oats, rye, or some other member of the grass family, to grow through the openings 35. The cover 5 also has a large opening 40 dimensioned to allow a person to extend his or her finger through the large opening 40 to feel the growing medium for moisture content. Yet, the large opening 40 must be dimensioned small enough to prevent limbs, such as a paw, from extending through the large opening 40 to pull on the grass.

The process of growing and maintaining the grass in the container 10 is detailed in the following explanation. A growing medium (not shown) is placed in the container 10 to a depth of approximately 4 centimetres. Typically the container is filled with a growing medium, such as garden soil. The growing medium is then heavily seeded with some member of the grass family, preferably oats. After seeding, an additional 1 centimetre approximately of growing medium is placed on top of the seeds to cover them. Finally, the cover 5 is placed over the container to protect the growing medium. In a preferred embodiment, the distance between the top surface of the growing medium and the cover 5 is approximately 1 to 2 centimetres. The numerous openings 35 in the cover 5 allow for watering the growing medium without removing the cover 5.

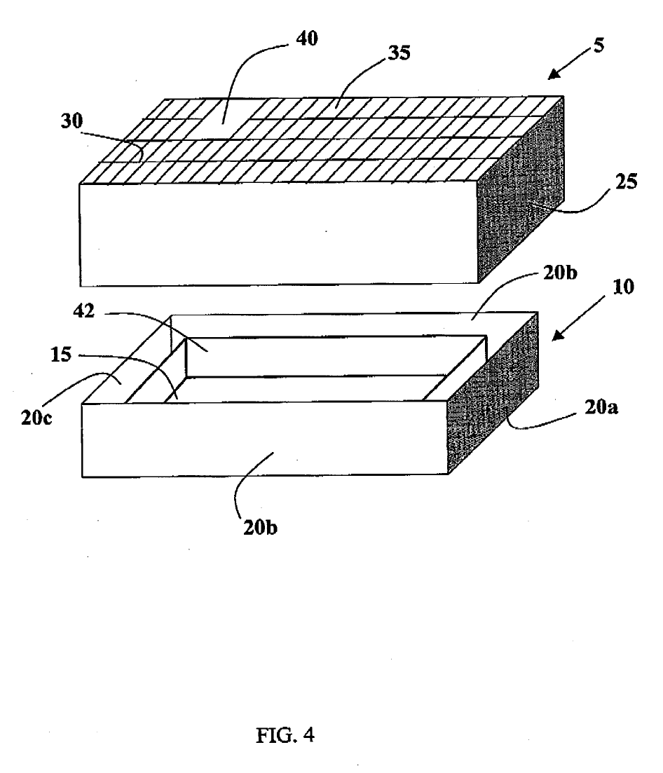

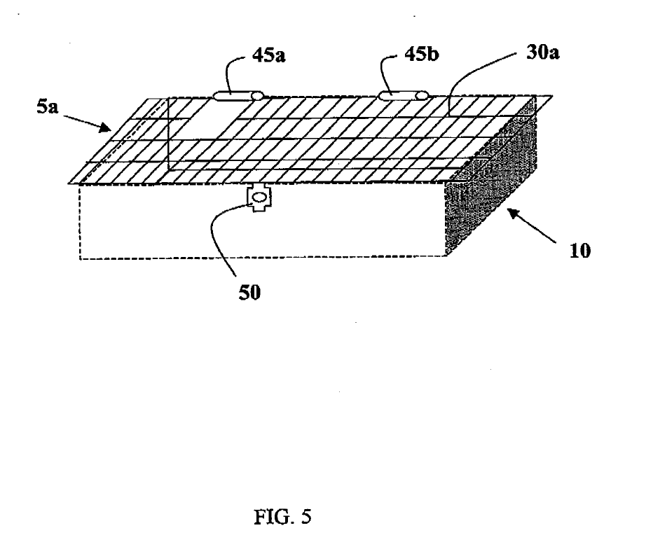

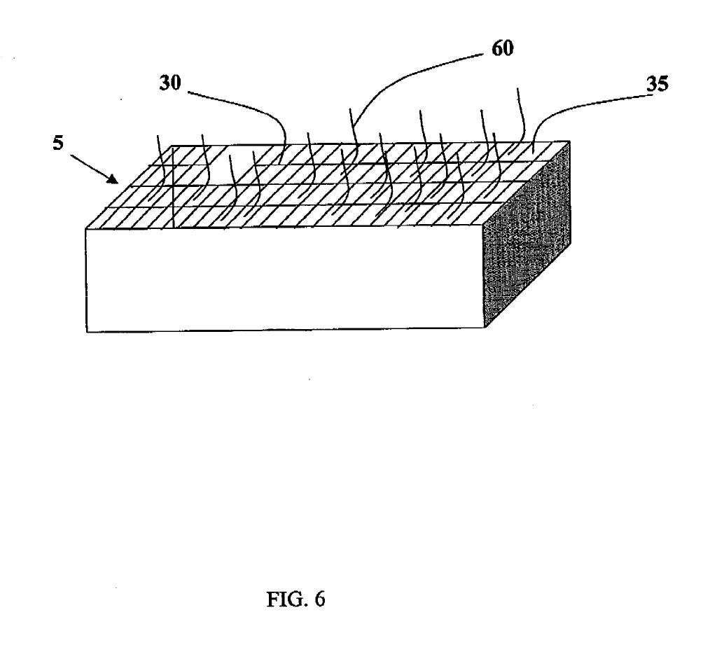

Periodically, the growing medium should be checked for moisture content by extending ones finger through the larger opening 40 in the cover 5 and feeling the growing medium in the container 10. After several days, the grass, element 60 in FIG. 4, germinates and grows through the openings 35 in the cover 5. It is recommended to allow the grass to grow to a height of approximately 5.0 to 7.5 centimetres, from the base end 15 of the container 10, before allowing a cat access to the container 10. By doing so, the grass is given sufficient time to establish a secure root system that will make it harder for cats to pull the grass out of the growing medium. If oats are used, the desired height is achieved usually within 9 days of sowing the seeds. The cover of the present invention thus enables cats to graze on the grass while preventing them from digging in the growing medium or pulling out the grass. It is recommended that a new batch of grass seeds be planted every three weeks, either by pulling out the old grass and re-seeding the growing medium, or replacing the growing medium and re-seeding. This re-seeding is recommended at three-week intervals as the grass will tend to wilt due to the shallow tray and indoor lighting conditions being less than optimal for grass growth.

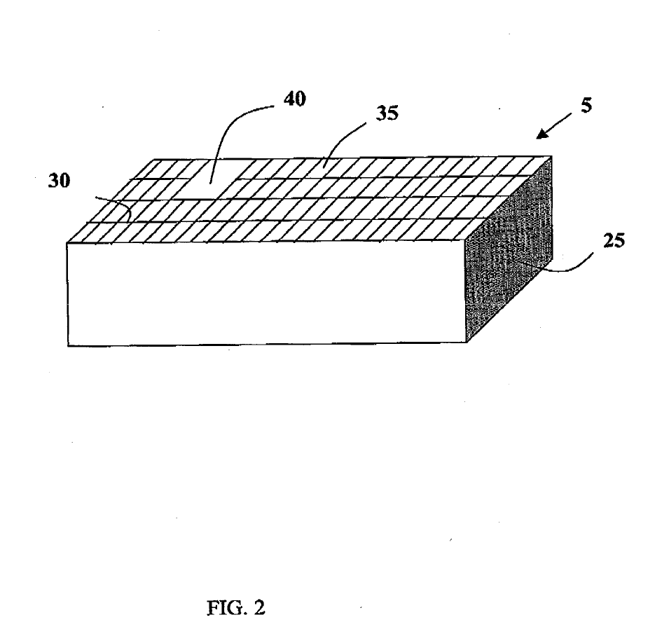

In a further embodiment, FIG. 2 illustrates a removable growing tray 42 placed within the container 10. The growing medium and grass seeds could be placed in the removable growing tray 42 rather than directly within the container 10. If the container 10 were made of materials such as wood, the removal of soil would be difficult. The use of a removable growing tray 42 is advantageous in that it facilitates the cleaning of the container 10.

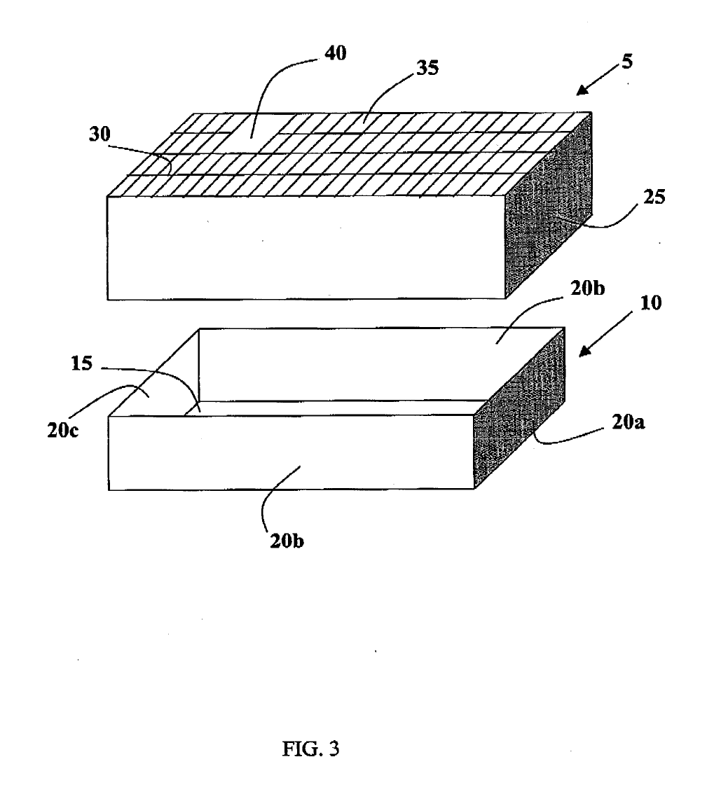

In an alternative embodiment, the cover 5 may be a grid that extends over, or along, the side walls of the container. FIG. 3 shows a modified cover 5a having a modified grid surface 30a which extends beyond the side walls of the container 10. The grid surface 30a does not have a frame 25 as in FIG. 1. The cover 5a is attached to the container 10 through use of two hinges 45a, 45b. While hinges 45a, 45b are shown in FIG. 3, screws, latches, or the like, may be utilized by the present invention. There is also shown a locking mechanism 50 for locking the cover 5a to the container 10. The locking mechanism 50 is useful in preventing small animals from removing or lifting the cover 5a.

It should be mentioned that the cover can be attached to the container by several other means, such as a latching mechanism, hook and loop fasteners, such as Velcro™ straps, elastic straps, or via a snap-on mechanism similar to the way a cover with dish snaps closes a container, such as Tupperware™.

FIG. 4 illustrates a cover 5 of the present invention placed over a grazing container (not clearly shown) where grass 60 is growing through the plurality of openings 35 in the grid surface 30.

With respect to materials used, the cover and container of the present invention made be of, but not limited to, any type of plastic, metal, or wood.

It is understood that the cover of the present invention may be utilized with many commercially available grass growing kits. For example, the container could be any shape, (e.g., oval-shaped) with a snap-on cover with numerous openings. The openings would be dimensioned large enough to allow grass to grow through and a person to extend his or her finger through to feel a growing medium for moisture content, yet having openings small enough to prevent cats paws from passing through. The openings need not be in a grid formation but may be positioned randomly or in many different patterns.

It should be understood that the preferred embodiments mentioned here are merely illustrative of the present invention. Numerous variations in design and use of the present invention may be contemplated in view of the following claims without straying from the intended scope and field of the invention herein disclosed.

1. (deleted)

2. (deleted)

3. (deleted)

4. (deleted)

5. (deleted)

6. (deleted)

7. (deleted)

8. (deleted)

9. deleted)

10. A cover for use with a container having suitable means for growing the at least one plant variety accessible to animals for grazing, the cover constructed and enclose the container and to prevent animals from displacing the cover relative to the container when enclosed, the cover having a plurality of openings being dimensioned to form a passageway for the at least one plant variety growing through the plurality of openings while the cover preventing a limb from an animal from entering through any one of the plurality of openings.

11. The cover as in claim 10, wherein the cover has at least one large opening dimensioned to allow a person to extend their finger through the at least one large opening to determine moisture content.

12. The cover as in claim 10, wherein the cover is made of material suitable for supporting weight applied on the cover by a cat.

13. (deleted)

14. (deleted)

15. (deleted)

16. (deleted)

17. (deleted)

18. (deleted)

19. The cover as in claim 10, wherein the cover further includes a frame having four side walls which are dimensioned to mate with four corresponding side walls of the container.

20. The cover as in claim 11, wherein the cover further includes a frame having four side walls which are dimensioned to mate with four corresponding side walls of the container.

21. The cover as in claim 12, wherein the cover further includes a frame having four side walls which are dimensioned to mate with four corresponding side walls of the container.

22. The cover as in claim 10 wherein the cover further includes attachment means for connecting the cover to the container.

23. The cover as in claim 10, wherein the at least one plant variety is grown from at least one grass seed, the at least one grass seed selected from the group consisting of: oats, rye, and a member of a mass seed family.
